(19) United States
(12) Patent Application Publication
(10) Pub. No.: US 2005/0172908 A1
(43) Pub. Date: Aug. 11, 2005

(54) Litter box for dogs

(76) Inventors: Simon Belgiorno, Repentigny (CA); Valerie Tessier, Repentigny (CA)

Correspondence Address: INVENTARIUM;Suite 1607, 4050 Rosemont blvd., Montreal, H1X 1M4, CA

(21) Appl. No.: 10/775,314

(22) Filed: Feb. 10, 2004

(51) Int. Cl. A01K 1/035

(52) U.S. Cl. 119/166

(57) ABSTRACT

A litter box for dogs having a container holding litter material as is known in the art but with the added improvement of a semi-permeable cover which can pass liquid waste, retain solid waste, and more importantly, separate the dog from the litter material, the semi-permeable cover is easily removable and easily cleanable for immediate reuse.

### BACKGROUND OF THE INVENTION

1. Field of the Invention

The invention relates generally to animal husbandry but more particularly to a platform onto which a dog can relieve itself and which is easy to clean.

2. Background of the Invention

Dogs are very much different than cats when it comes to relieving themselves. Whereas cats are, by nature, very neat and can easily be trained to use a litter, dogs usually make a mess of the litter, spreading its content all over. It is usually preferable to take the dog outside. In some situation, going outside is not practical and dog owners have trained their dogs to go to a specific place for relieving themselves. Usually on old newspapers. There are special washable or disposable mats sold in the marketplace but they are costly and do not offer major advantages over trusty old newspapers. There is therefore a need for a better litter for dogs.

### SUMMARY OF THE INVENTION

It is a main advantage of this invention to provide for a litter box having two parts: a litter container and a separable cover part on which a dog will sets itself. The litter material being isolated from the dog is not dispersed out by the dog.

It is another advantage of this invention to provide for a dog litter box which is easy to clean.

In order to do so, the invention comprises a container holding litter material as is known in the art but with the added improvement of a semi-permeable cover, onto which a dog will climb, and which can pass liquid waste, retain solid waste, and more importantly, separate the dog from the litter material, the semi-permeable cover is easily removable and easily cleanable for immediate reuse.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

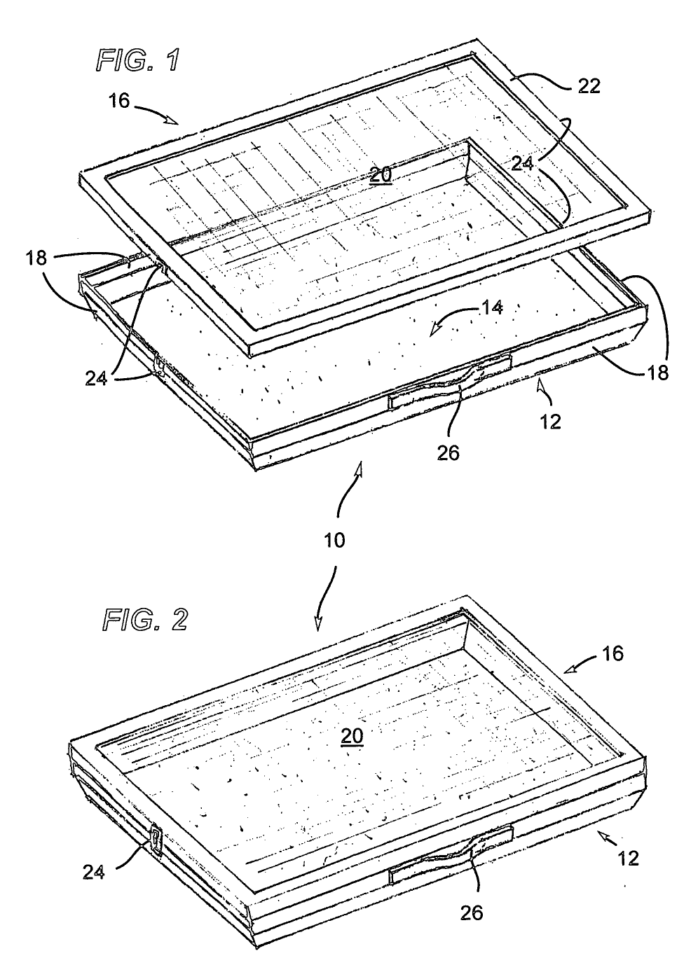

FIG. 1 Exploded orthogonal view of the dog litter box.

FIG. 2 Orthogonal view of the dog litter box with cover installed.

### DETAILED DESCRIPTION OF THE PREFERRED EMBODIMENT

A litter box for dogs (10) has a container part (12) holding litter material (14) as is known in the art, and a semi-permeable cover (16) configured and sized to be removably fitted on four walls (18) delimiting the container part (12). The semi-permeable cover (16) is made, in part, of a partitioning material (20) framed inside a solid frame (22) and the partitioning material (20) is made of a material that is strong enough to support the weight of a dog, and durable while offering permeable properties adequate for passing liquids but not necessarily solid wastes or even the litter material (14) in order to fully isolate a dog from the litter material (14), therefore impermeable to both solid wastes and litter but permeable to liquids, which makes it overall semi-permeable. The semi-permeable cover (16) is easily removable from the container part (12) either by undoing fastening means (24) (only one shown) such as fastening clips or the likes or simply through frictional insertion between the semi-permeable cover (16) and the container part (12). The semi-permeable material (20) of the semi-permeable cover (16) does not absorb excrements and is not stained by them nor does it retain odors as long as all the excrements are removed and wiped off with a damp rag. Any other methods, such as hosing down the semi-permeable cover (16), is left at the discretion of the dog carer. Optionally, the litter box for dogs (10) can also have a practical and adequately positioned handle (26) for use when going on a trip or simply moving the litter box for dogs (10) around.

1. A litter box for dogs having a container part for holding litter material and having the following improvement:
a semi-permeable cover configured and sized to be removably fitted on four walls delimiting said container part;
said semi-permeable cover made of a partitioning material that is tough and durable while offering permeable properties adequate for passing liquids but not necessarily solid wastes or even said litter material in order to fully isolate a dog from said litter material;
said semi-permeable cover comprised of a solid frame within which said partitioning material is framed.

2. A litter box for dogs as in claim 1 wherein
said semi-permeable cover has a fastening means to fasten it to said container part.

3. A litter box for dogs as in claim 2 wherein said fastening means is selected from the group comprised of but not limited to fastening clips.

4. A litter box for dogs as in claim 1 further comprised of a handle.

5. A litter box for dogs as in claim 2 further comprised of a handle.

6. A litter box for dogs as in claim 3 further comprised of a handle.
